(19) United States
(12) Patent Application Publication
(10) Pub. No.: US 2026/0091555 A1
(43) Pub. Date: Apr. 2, 2026

(54) SYSTEMS AND METHODS FOR PRINTING THREE-DIMENSIONAL OBJECTS

(71) Applicant: BIOMET 3I, LLC, Palm Beach Gardens, FL (US)

(72) Inventor: Zachary B. Suttin, Jupiter, FL (US)

(21) Appl. No.: 19/345,803

(22) Filed: Sep. 30, 2025

Related U.S. Application Data
(60) Provisional application No. 63/701,253, filed on Sep. 30, 2024.

(51) Int. Cl. B29C 64/386; A61C 5/77; A61C 13/00; B33Y 50/00; B33Y 80/00

(52) U.S. Cl. CPC B29C 64/386; A61C 5/77; A61C 13/0004; A61C 13/0019; B33Y 50/00; B33Y 80/00

(57) ABSTRACT

Dental restoration technologies include dental prosthesis components such as implants, abutments, crowns, and the like that are mapped to a patient's mouth prior to and during installation. Fabricating at least a portion of one or more components of the dental prosthesis using a fully calibrated and characterized fabricator can reduce sources of error that affect the success of fabrication and installation processes. The components of the dental prosthesis are represented by library files that are tailored to reflect particular characteristics of the components of the prosthesis to be fabricated, the fabricator, the material used during fabrication, and/or the environment surrounding the fabricator. The library files may be determined based on an acquired scan of the patient and/or based on inputs received from a user during the design process. The library files may be generated using virtual modeling techniques, and/or based on a component design that falls within pre-determined parameters.

### CROSS-REFERENCE TO RELATED APPLICATION

This U.S. Non-Provisional patent application claims the benefit of priority under 35 U.S.C. § 119(e) of U.S. Provisional Patent Application Ser. No. 63/701,253, filed Sep. 30, 2024, the entire disclosure of which is hereby incorporated by reference.

### FIELD OF THE DISCLOSURE

The disclosure relates to printing three-dimensional objects as part of a digital dental workflow and, in particular, is directed to systems and methods for printing three-dimensional components for dental prosthesis technologies.

### BACKGROUND

The background description includes information that may be useful in understanding the present inventive subject matter. It is not an admission that any of the information provided herein is prior art or relevant to the presently claimed disclosure, or that any publication specifically or implicitly referenced is prior art.

Dental restoration technologies include dental prosthesis components such as implants, abutments, crowns, models, and the like that may be mapped to a patient's mouth prior to, during, or after installation. Existing prostheses have traditionally been fabricated from gold or, more recently, zirconia. Excess torque on improperly-seated prostheses such as those fabricated from zirconia, however, can increase the chances of the prostheses snapping or otherwise breaking during or after installation (e.g., due to improper fitting and/or damage caused during installation). As such, it is critical to map a prosthesis to the patient's mouth as closely as possible, including to ensure the proper seating of the prosthesis within the patient's mouth during and after installation.

### SUMMARY

Components of a prosthesis may include sources of error during fabrication, such as when forming the dimensions of a particular component geometry. For example, components of a prosthesis may include, but are not limited to, an implant, an abutment, a cap or crown, a bridge, fasteners, plugs, and the like. Where there are multiple components that together form the prosthesis, the sources of errors may compound (or stack), increasing the overall amount of error in the prosthesis.

In addition, existing tools used for the fabrication and/or installation of the components of the prosthesis need to be validated, which can provide a metric of timing for re-calibration of the tool (and/or a metric of timing for replacement of the tool). However, the validation only provides a personality for the particular tool being validated, and not necessarily for every similar or same installation tool. As such, sources of error may also be added to the components of the prosthesis (and the prosthesis as a whole) by an improperly-calibrated tool, or a tool in need of replacement, which may additionally increase the possibility of breakage of the prosthesis during or after installation.

Further, to test a quality of fit and/or an accuracy of fit of a particular prosthesis or prosthesis component, a test jig may be used. The test jig includes holes along a plus-minus scale. The prosthesis component is fitted into the various holes of the jig, while a largely subjective determination is made about how well the component feels like it fits within a particular hole. Although not an actual metric, the feel-fit test can be implemented to determine whether the prosthesis component has an appropriate geometry for installation. The feel-fit test can therefore create sources of error in the components of the prosthesis (and the prosthesis as a whole) based on user judgment, in addition to sources of error in the actual fabrication of the components of the prosthesis.

As such, there are sources of error that exist during the fabrication and installation of a prosthesis, which may affect the proper placement of the prosthesis components and/or which may increase the possibility of breakage during or after installation. The sources of error may be compounded (or stacked) within the geometries of each respective prosthesis component, and/or between the various steps of fabrication and installation of the prosthesis, including but not limited to errors in component dimensions and/or errors during fabrication (e.g., in the fabrication processes, in the calibration of the fabricator, or the like).

Recent advancements in dental implant technologies include the use of three-dimensional (“3D”) printed components for a dental prosthesis for prosthesis solutions such as conventional crown and bridge dentistry. A dental prosthesis can also be assembled from components including an implant and/or an abutment. The implant and the abutment interlock together with mating features that are fabricated using machining processes that are more precise than what may be possible with 3D printing when a digital model is translated to a physical (or analog) printed component.

Because the machining creates a higher level of precision than what may be accomplished with a 3D printed component, the interface between a 3D printed component and a high-precision machined component is a self-limiting aspect of the technology that creates a bottleneck in making improvements to 3D printing technologies for a dental prosthesis. This is observed even if the geometry of the prosthesis components is known, and is incorporated into the corresponding 3D printed model, due to sources or errors within the processes of fabricating and installing the dental prosthesis and/or due to the uniqueness of a particular 3D printer.

However, despite the bottlenecking or limitations that are currently observed in emerging 3D dental technologies, 3D printing to fabricate unique or custom components is increasing in popularity. 3D printing generally requires the consideration of factors such as printer type, costs for the printer and printer accessories, case of use of the printer, level or amount of accuracy of the printer, and timing and/or need for calibration of the printer. In addition, operational parameters of the printer such as temperature, orientation of a printed component within the printer, fabricating material (e.g., resin, or the like) that may be usable for a particular end product, and surrounding environment issues such as humidity and temperature also need to be taken into consideration.

3D printers often have a unique signature or personality, the understanding of which requires monitoring some or all of the non-limiting factors listed above. These unique personalities increase the difficulty of providing a set or known mating geometry for a resultant 3D prosthesis, as the mating geometry for the prosthesis (and the components that comprise the prosthesis) can be influenced by the unique personalities. The unique personalities are created from combinations of factors, which also increases the difficulty of improving validation processes for the 3D printers as the factors influencing the personality of the printers change and expand with frequency.

One solution is to produce a calibration file containing variations for a given mating geometry. For example, the variations may be generated by scaling a design, to create a non-limiting number of variations (e.g., 100 variations, or the like) of a particular mating geometry. Using the variations as a starting point, a user (e.g., a lab technician, a clinician, a surgeon, or another medical professional) may indicate a particular variant (e.g., number 77 out of 100) has a preferred quality of fit and/or accuracy of fit, similar to the physical jig-based feel-fit test currently implemented during fabrication and/or installation processes for the dental prosthesis. A 3D printing library file for the prosthesis based on the mating geometry can then be adapted based on the elected variant, to be specific to the patient. When a user prints the prosthesis component (e.g., from a 3D model with an analog pocket, a coping with a titanium base post pocket, a crown with an abutment post pocket, and the like), respective prosthesis components (e.g., implant analogs, titanium bases and patient-specific abutments, and the like) will preferably properly mate with an increased chance of success. This solution is observed when mating the components of the prosthesis.

Another solution is to print a test component with a known geometry, data for which can be acquired (e.g., during fabrication or during installation testing), and then perform an overlay or difference map to determine how to change or correct errors into the 3D printing library file. The overlay or difference map allows a user to iteratively correct the 3D printing library file, so that the output more closely matches the desired output. This solution addresses errors in the 3D printed prosthesis, which may differ from scanning an assembly to detect errors from an assembled machined-printed assembly.

As 3D printing technologies improve, then, it is desirable to further digitize the process of fabricating and installing a dental prosthesis. Ultimately, it would be desirable to have the entire prosthesis fabricated using 3D printing technologies, from initial design and testing to the final fabrication and installation of the prosthesis within the patient. This would allow for an immediate initial reduction (or removal) of select sources of error, including those related to using multiple machines during fabrication and/or materials from which the components of the prosthesis are fabricated.

However, digitizing the majority (or all) of the processes used to fabricate and/or fine-tune and install a dental prosthesis may create additional sources of error. For example, additional sources of error may be introduced in the various scanning, modelling, printing, and cleaning stages of the process of fabricating and installing the dental prosthesis. These sources of error may be compounded for a partial arch impression, or even a full arch impression, as compared to a prosthesis for a single tooth.

As such, there exists a need for improvements in the fabricating and installing a dental prosthesis while utilizing 3D printing technologies. The improvements should include updates to the calibration assessment of fabricators such as 3D printers. For example, the updates should reduce an impact to the components of the prosthesis caused by the 3D printer itself, by a particular resin or other fabricating material used by the 3D printer to fabricate the components of the prosthesis, and/or by the environment surrounding the 3D printer.

In addition, the improvements should include updates to determine the quality of fit and/or accuracy of fit for the fabricated components of the prosthesis. For example, the prosthesis components may be monitored with a post-assessment scan to determine the correctness of the quality of fit and/or accuracy of fit. In some instances (e.g., such as where the prosthesis is an assembly including an implant, and abutment, and a crown), tolerances of fit are critical to ensure an overall stack-up dimension for the components of the prosthesis. In addition, tolerances of fit are critical to ensure an appropriate level of force of a snap on/snap off retention between the components of the prosthesis. Further, tolerances of fit are critical to ensure a particular strength of the assembled prosthesis during and after installation within the patient.

In one non-limiting example, a quality of fit may be determined from a visual, haptic, and/or aural indicator when components of the prosthesis are mated. For instance, an aural indicator may include a snap, a click, or another sound during engagement between a set of prosthesis components, to provide an increased accuracy over visual and/or haptic inspection alone. A recorded sound (e.g., an artificially-designed sound or a sound at (or resulting from) a natural frequency) emitted during the mating of prosthesis components may be compared against a database to determine whether a part is either (a) correct as it has a particular sound or is within a predetermined threshold or range of sounds, or (b) incorrect as it has a particular sound that exceeds the predetermined threshold or range of sounds. Where the sound is determined to be incorrect for a desired mating of components of the prosthesis, the sound may be further compared to the database (or other data) to determine whether a particular component of the prosthesis should be differently sized (e.g., go up or down in size as a variant of the selected geometry, and/or should be a number for a different geometry entirely, within the prosthesis model). To assist in this determination, calibration sounds and/or test sounds may be recorded to determine whether the fabricated components of the prosthesis are correct, incorrect, or at an in-between state (and needing to be adjusted to become correct).

It is noted the sound calibration could be employed in prosthesis assemblies employing a snap-fit, but that a snap-fit is not required to implement the sound calibration. In general, the mating of components of the prosthesis may be monitored with a predetermined corresponding audible signature or frequency, to ensure a desired level for a quality of fit is achieved based on an increased level of accuracy and confidence in calibration.

In another non-limiting example, an accuracy of fit may be determined from measurements or dimensions taken of individual components and/or of a stack or assembly of a component of components, including optionally the entire prosthesis. Where the measurements and/or dimensions are determined to be incorrect for a desired mating of components of the prosthesis, the measurements and/or dimensions may be further compared to the database (or other data) to determine whether a particular component of the prosthesis should be differently sized (e.g., go up or down in size as a variant of the selected geometry, and/or should be a number for a different geometry entirely, within the prosthesis model). To assist in this determination, calibration measurements and/or dimensions may be recorded to determine whether the fabricated components of the prosthesis are correct, incorrect, or at an in-between state (and needing to be adjusted to become correct).

In another non-limiting example, a quality of fit and/or an accuracy of fit may be determined from a 3D printing of a given geometry for a component of the prosthesis that is used as a global test component for a particular 3D printer. From the global test component, a library file for a particular component of the prosthesis, and/or all library files for the components of the prosthesis assembly, may be tailored for the unique personality of the 3D printer. It is noted this may occur for either a “set” of components of the prosthesis that include the same geometry that has been modified (e.g., scaled in size, or the like) or a “combination” of components of the prosthesis that include different or unique geometries (e.g., which can have different scales).

However, it is contemplated in the present disclosure that 3D printers may be validated and delivered in a hermetically-sealed state to recreate a known geometry regardless of location of printer installation and/or use. Although the individual 3D printers within the same batch of hermetically-sealed deliverables may have a particular personality, the particular personality should be shared within the group of individual 3D printers. In this regard, the validation and calibration for each 3D printer would be similar regardless of location.

Where potentially-uncontrollable factors such as environment humidity and temperature factor into the personality of the 3D printers, the 3D printers could be able to sample the surrounding environment. From the sample data, the 3D printer may adjust operational parameters and/or adjust a library file selection in response, including to optionally maintain parameters identical to the validation and calibration of the hermetically-sealed state.

Further, improvements should include the generation of a collection of library files for every known 3D printer and every known environment. The 3D printer could store the collection of library files and/or receive the library files from an external source in communication with the 3D printer. The 3D printer (and/or the external source) sorts through the library of files based on inputs received from a user, until a geometry is determined that provides the best quality of fit and/or accuracy of fit. In one non-limiting example, a user may select a particular geometry from a non-limiting number of variations (e.g., number 77 out of 100) for based on an initial quality of fit and/or accuracy of fit, and then may be provided with another collection of library sub-files (and/or a single custom library file) based on the selection of the particular geometry. In another non-limiting example, a user may select a particular geometry from a non-limiting number of variations (e.g., number 77 out of 100) for based on an initial quality of fit and/or accuracy of fit, which may then be adjusted or otherwise modified by the user or another individual to improve to quality of fit and/or accuracy of fit from the initial closeness.

Embodiments of the present disclosure are directed to a systems and methods for fabrication of three-dimensional objects as part of a digital dental workflow. In particular, embodiments are directed to systems and methods for printing components for dental prosthesis technologies.

In embodiments, components of a prosthesis are printed using a 3D printer based on determined library files that correspond to a desired prosthesis geometry (or set of geometries, for the various components of the prosthesis). The library files also correspond to the personality of a particular 3D printer being used to fabricate the components of the prosthesis.

Embodiments of the present disclosure are directed to calibrating the 3D printer and/or selecting geometries for components of the prosthesis based on acquired scan data and optional design processes (e.g., implementing virtual modeling techniques or technologies). Embodiments of the present disclosure are also directed to selecting geometries for components of the prosthesis from a database based on inputs received from a user (e.g., a lab technician, a clinician, a surgeon, or another medical professional).

Embodiments of the present disclosure are also directed to calibrating the 3D printer and/or selecting geometries for components of the prosthesis from a database including a collection of library files. The collection of library files includes files that are pre-determined for the geometry of the prosthesis and/or determined for particular characteristics (e.g., personalities) of a 3D printer to be used during fabrication of the prosthesis.

In some embodiments, the components of the prosthesis are fabricated, and a quality of fit and/or accuracy of fit is determined for the components of the prosthesis. The quality of fit may be determined based on indicators including visual, haptic, and/or aural indicators. Optionally, the indicators may be recorded and compared to stored (e.g., pre-recorded) library files or other data, to determine whether a quality of fit having a particular value (or falling within a threshold or range of values) is observed. The accuracy of fit may be determined based on measurements or dimensions taken of individual components and/or of a stack or assembly of a component of components, including optionally the entire prosthesis. Optionally, the measurements or dimensions may be recorded and compared to stored (e.g., pre-determined) library files (or other data), to determine whether an accuracy of fit having a particular value (or falling within a threshold or range of values) is observed.

Where a desired quality of fit and/or accuracy of fit is not observed, operational parameters for the fabricator may be adjusted and/or the selected geometry may be iterated until the quality of fit and/or accuracy of fit reaches the pre-determined threshold. Alternatively, where the desired quality of fit and/or accuracy of fit is observed, the operational parameters for the fabricator may be stored for usage and/or calibration when fabricating additional assemblies including the components of the prosthesis. The stored operational parameters may, at least in part, be used during a subsequent fabrication process, such as where library files are determined based on input from a user to select geometries for the components of the prosthesis.

A first aspect of the present disclosure is to provide a system for printing three-dimensional components for dental prosthesis technologies, substantially as described herein.

A second aspect of the present disclosure is to provide a 3D printer for printing three-dimensional components for dental prosthesis technologies, substantially as described herein.

A third aspect of the present disclosure is to provide a computational system comprising a processor and computer readable medium comprising instructions that, when executed, perform one or more operations substantially as described herein.

A fourth aspect of the present disclosure is to provide a computer readable medium comprising instructions that, when executed, perform one or more operations substantially as described herein.

A fifth aspect of the present disclosure is to provide a method to digitally process one or more scan images substantially as described herein to design a dental restoration.

A sixth aspect of the present disclosure is to provide a method to digitally process a plurality of library files utilized to calibrate a fabricator and/or fabricate one or more components of a prosthesis, substantially as described herein.

A seventh aspect of the present disclosure is to provide a computer readable medium comprising a plurality of library files utilized to calibrate a fabricator and/or fabricate one or more components of a prosthesis, substantially as described herein.

An eighth aspect of the present disclosure is to provide a system for fabricating three-dimensional components for dental prosthesis technologies. The system includes a fabricator for fabricating at least one component of a dental prosthesis. The system includes a computer with a processor and computer readable medium comprising instructions. When executed, the instructions cause the processor to calibrate the fabricator, where the fabricator is calibrated based on a library file of a collection of pre-determined library files, and where the library file includes at least one of a virtual model for the at least one component of the dental prosthesis to be fabricated, and one or more operational parameters for the fabricator. When executed, the instructions cause the processor to fabricate the at least one component of the dental prosthesis using the fabricator. When executed, the instructions cause the processor to determine at least one of a quality of fit and an accuracy of fit of the at least one component of the dental prosthesis.

The system of the eighth aspect may include, optionally, that the library file is selected based on at least one of inputs received from a user via the computer and acquired scan data of a patient.

The system of the eighth aspect may include one or more of the previous embodiments and, optionally, that the collection of pre-determined library files is stored in a database.

The system of the eighth aspect may include one or more of the previous embodiments and, optionally, when executed, the instructions cause the processor to acquire the scan data of the patient.

The system of the eighth aspect may include one or more of the previous embodiments and, optionally, when executed, the instructions cause the processor to design the virtual model of the at least one component of the dental prosthesis based on the acquired scan data.

The system of the eighth aspect may include one or more of the previous embodiments and, optionally, that the at least one component of the dental prosthesis includes a first component and a second component. The quality of fit and/or the accuracy of fit is determined during engagement of the first component and the second component based on an indicator.

The system of the eighth aspect may include one or more of the previous embodiments and, optionally, that the indicator is an aural indicator emitted during engagement of the first component and the second component. The aural indicator emitted during engagement of the first component and the second component is dependent on at least one of a material from which at least one of the first component and the second component is fabricated, and one or more features formed on at least one of the first component and the second component.

The system of the eighth aspect may include one or more of the previous embodiments and, optionally, that the aural indicator emitted during engagement of the first component and the second component is compared to a pre-determined aural indicator (or other data) stored in the computer readable medium of the computer.

The system of the eighth aspect may include one or more of the previous embodiments and, optionally, that the indicator is a haptic indicator generated during engagement of the first component and the second component.

The system of the eighth aspect may include one or more of the previous embodiments and, optionally, that the indicator is a visual indicator observed during engagement of the first component and the second component. The visual indicator includes one or more indicator markers formed on at least one of the first component and the second component.

The system of the eighth aspect may include one or more of the previous embodiments and, optionally, when executed, the instructions cause the processor to adjust the at least one component of the dental prosthesis based on the determined at least one of a quality of fit and an accuracy of fit by modifying the virtual model of the at least one component of the dental prosthesis, where the determined at least one of a quality of fit and an accuracy of fit does not meet a pre-determined threshold. When executed, the instructions cause the processor to re-fabricate the at least one component of the dental prosthesis using the fabricator based on the modified virtual model.

The system of the eighth aspect may include one or more of the previous embodiments and, optionally, when executed, the instructions cause the processor to adjust one or more operational parameters of the fabricator based on the determined at least one of a quality of fit and an accuracy of fit, where the determined quality of fit does not meet a pre-determined threshold.

The system of the eighth aspect may include one or more of the previous embodiments and, optionally, when executed, the instructions cause the processor to store one or more operational parameters of the fabricator, where the determined at least one of a quality of fit and an accuracy of fit does meet a pre-determined threshold.

The system of the eighth aspect may include one or more of the previous embodiments and, optionally, that the fabricator is a three-dimensional printer.

A ninth aspect of the present disclosure is to provide a method for fabricating three-dimensional components for dental prosthesis technologies. The method may include, but is not limited to, calibrating a fabricator for manufacturing at least one component of a dental prosthesis. The fabricator is calibrated based on a library file of a collection of pre-determined library files. The library file includes at least one of a virtual model for the at least one component of the dental prosthesis to be fabricated, and one or more operational parameters for the fabricator. The method may include, but is not limited to, fabricating the at least one component of the dental prosthesis using the fabricator. The method may include, but is not limited to, determining at least one of a quality of fit and an accuracy of fit of the at least one component of the dental prosthesis.

The method of the ninth aspect may include, optionally, acquiring scan data of a patient. The method may include, but is not limited to, receiving inputs from a user. The library file is selected based on the acquired scan data and/or the received inputs.

The method of the ninth aspect may include one or more of the previous embodiments and, optionally, designing the virtual model of the at least one component of the dental prosthesis based on the acquired scan data.

The method of the ninth aspect may include one or more of the previous embodiments and, optionally, adjusting the at least one component of the dental prosthesis based on the determined at least one of a quality of fit and an accuracy of fit by modifying the virtual model of the at least one component of the dental prosthesis, where the determined at least one of a quality of fit and an accuracy of fit does not meet a pre-determined threshold. The method may include, but is not limited to, re-fabricating the at least one component of the dental prosthesis using the fabricator based on the modified virtual model.

The method of the ninth aspect may include one or more of the previous embodiments and, optionally, adjusting one or more operational parameters of the fabricator based on the determined at least one of a quality of fit and an accuracy of fit, where the determined at least one of a quality of fit and an accuracy of fit does not meet a pre-determined threshold.

The method of the ninth aspect may include one or more of the previous embodiments and, optionally, storing one or more operational parameters of the fabricator, where the determined at least one of a quality of fit and an accuracy of fit does meet a pre-determined threshold.

A tenth aspect of the present disclosure is directed to a non-transient computer-readable medium having stored thereon instructions that cause a process to execute a method. The method may include, but is not limited to, instructions to calibrate a fabricator for manufacturing at least one component of a dental prosthesis. The fabricator is calibrated based on a library file of a collection of pre-determined library files. The library file includes at least one of a virtual model for the at least one component of the dental prosthesis to be fabricated, and one or more operational parameters for the fabricator. The method may include, but is not limited to, instructions to provide fabrication instructions to the fabricator to fabricate the at least one component of the dental prosthesis. The method may include, but is not limited to, instructions to determine at least one of a quality of fit and an accuracy of fit of the at least one component of the dental prosthesis.

An eleventh aspect of the present disclosure is to provide a system for fabricating at least a portion of one or more three-dimensional components for dental prosthesis technologies. The system includes a fabricator for fabricating at least a portion of one or more components of a dental prosthesis. The system includes a computer with a processor and computer readable medium comprising instructions. When executed, the instructions cause the processor to calibrate the fabricator, where the fabricator is calibrated based on a library file of a collection of pre-determined library files, and where the library file includes at least one of a virtual model for the at least a portion of one or more components of the dental prosthesis to be fabricated, and one or more operational parameters for the fabricator. When executed, the instructions cause the processor to fabricate the at least a portion of one or more components of the dental prosthesis using the fabricator. When executed, the instructions cause the processor to determine at least one of a quality of fit and an accuracy of fit of the at least a portion of one or more components of the dental prosthesis.

A twelfth aspect of the present disclosure is to provide a method for fabricating at least a portion of one or more three-dimensional components for dental prosthesis technologies. The method may include, but is not limited to, calibrating a fabricator for manufacturing at least a portion of one or more components of a dental prosthesis. The fabricator is calibrated based on a library file of a collection of pre-determined library files. The library file includes at least one of a virtual model for the at least a portion of one or more components of the dental prosthesis to be fabricated, and one or more operational parameters for the fabricator. The method may include, but is not limited to, fabricating the at least a portion of one or more components of the dental prosthesis using the fabricator. The method may include, but is not limited to, determining at least one of a quality of fit and an accuracy of fit of the at least a portion of one or more components of the dental prosthesis.

A thirteenth aspect of the present disclosure is directed to a non-transient computer-readable medium having stored thereon instructions that cause a processor to execute a method. The method may include, but is not limited to, instructions to calibrate a fabricator for manufacturing at least a portion of one or more components of a dental prosthesis. The fabricator is calibrated based on a library file of a collection of pre-determined library files. The library file includes at least one of a virtual model for the at least a portion of one or more components of the dental prosthesis to be fabricated, and one or more operational parameters for the fabricator. The method may include, but is not limited to, instructions to provide fabrication instructions to the fabricator to fabricate the at least a portion of one or more components of the dental prosthesis. The method may include, but is not limited to, instructions to determine at least one of a quality of fit and an accuracy of fit of the at least a portion of one or more components of the dental prosthesis.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

Unless otherwise indicated, all numbers expressing quantities, dimensions, conditions, and so forth used in the specification and claims are to be understood as being modified in all instances by the term “about.”

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary, brief description of the drawings, detailed description, abstract, and claims themselves.

All external references are hereby incorporated by reference in their entirety whether explicitly stated or not.

These and other advantages will be apparent from the disclosure contained herein. The above-described embodiments, objectives, and configurations are neither complete nor exhaustive. It is intended neither to identify key or critical elements of the disclosure nor to delineate the scope of the disclosure but to present selected concepts of the disclosure in a simplified form as an introduction to the more detailed description presented below. The Summary is neither intended nor should it be construed as being representative of the full extent and scope of the present disclosure. Moreover, references made herein to “the present disclosure,” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

It is to be appreciated that any embodiment, feature, or aspect described herein can be claimed in combination with any other embodiment(s), feature(s), or aspect(s) as described herein, regardless of whether the features or aspects come from the same described embodiment. For example, any one or more aspects described herein can be combined with any other one or more aspects described herein. In addition, any one or more features described herein can be combined with any other one or more features described herein. Further, any one or more embodiments described herein can be combined with any other one or more embodiments described herein.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments and together with the general description of the disclosure given above and the detailed description of the drawings given below, serve to explain the principles of the disclosure.

FIG. 1A illustrates a system for printing three-dimensional objects, in accordance with one or more embodiments of the present disclosure;

FIG. 1B illustrates a variation of the system for printing three-dimensional objects in FIG. 1A;

FIG. 1C illustrates a variation of the system for printing three-dimensional objects in FIG. 1A:

FIG. 2A illustrates a process flow diagram of a method for printing three-dimensional objects;

FIG. 2B illustrates a process flow diagram of a method for printing three-dimensional objects;

FIG. 3A illustrates a side elevation view of a prosthesis including an implant, an abutment, and a crown in a disassembled arrangement;

FIG. 3B illustrates a top plan view of the implant and the abutment of the prosthesis of FIG. 3A;

FIG. 3C illustrates a side elevation view of the prosthesis including the implant, the abutment, and the crown of FIG. 3A in an assembled arrangement; and

FIG. 3D illustrates a top plan view of the implant, the abutment, and the crown of the prosthesis of FIG. 3C.

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein. It is noted that any line in the drawings may be illustrated as solid or broken lines, including any section or length of each individual line, without departing from the scope of the present disclosure. It will be appreciated that recitation of, for example, reference character 117, 117A, 117B, etc. may apply to any combination of reference characters 117, 117A, 117B, etc.

| Reference Number | Component |
|---|---|
| 100A, 100B, 100C | System |
| 102 | Fabricator |
| 104 | Processor |
| 106 | Memory |
| 108 | Computer |
| 110 | Processor |
| 112 | Memory |
| 114 | Database |
| 116 | Library Files |
| 118 | Communication Channels |
| 120 | User Interface |
| 122 | Displays |
| 124 | Sensors |
| 200 | Method or Process |
| 202 | Acquire Scan Data |
| 204 | Design a Prosthesis |
| 206 | Calibrate a Fabricator |
| 208 | Fabricate the Prosthesis |
| 210 | Determine a Quality of Fit and/or |
| | an Accuracy of Fit of the Prosthesis |
| 212 | Adjust Design of Prosthesis and/or |
| | Operational Parameters |
| | of the Fabricator Based on the Quality |
| | of Fit and/or the |
| | Accuracy of Fit of the Prosthesis |
| 214 | Store Operational Parameters |
| | of the fabricator |
| 220 | Method or Process |
| 222 | Determine a Library File for a Prothesis |
| 300 | Prosthesis |
| 302 | Implant |
| 304 | Abutment |
| 306 | Crown |
| 308 | Aural Indicator |
| 310 | Haptic Indicator |
| 312 | Visual Indicator |

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment since describing every possible embodiment of the systems and methods for printing three-dimensional (3D) components for dental prosthesis technologies would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the systems and methods for printing 3D components for dental prosthesis technologies can be combined with dimensions, aspects, and features of another embodiment of the systems and methods for printing 3D components for dental prosthesis technologies to create the claimed embodiment.

In general, embodiments of the present disclosure are directed to printing three-dimensional objects as part of a digital dental workflow and, in particular, is directed to systems and methods for printing three-dimensional components for dental prosthesis technologies.

Embodiments of the present disclosure are also directed to systems and methods that utilize a fabricator to fabricate components of a prosthesis based on library files. In embodiments, the library files may be selected based on acquired scan data of a patient (and/or may be designed based on the acquired scan data). The library files may be selected following inputs from a user (e.g., a lab technician, a clinician, a surgeon, or another medical professional). The generated design and/or the library files include a particular geometry (or geometries) for the prosthesis (and the components of the prosthesis).

In embodiments, the components of the prosthesis are fabricated, and a quality of fit and/or an accuracy of fit is determined for the fabricated parts. The quality of fit may be based on haptic, visual, and/or aural indicators. The indicators may be compared to standard indicators (or other data), to determine whether the value (or a threshold or range of values) is met by the fabricated components of the prosthesis. The accuracy of fit may be based on measurements or dimensions of the individual components of the prosthesis and/or assemblies of the components. The measurements or dimensions may be compared to pre-determined measurements or dimensions (or other data), to determine whether the value (or a threshold or range of values) is met by the fabricated components of the prosthesis. Where the value (or a threshold or range of values) is not met, the components of the prosthesis and/or operational parameters of the fabricator may be modified or reproduced through one or more iterations until the value (or a threshold or range of values) is met.

In embodiments, operational parameters of the fabricator are adjusted based on the components of the prosthesis, aspects of the fabricator, properties of the material used to fabricate the components of the prosthesis, and/or from the surrounding environment. In embodiments, operational parameters of the fabricator may be stored for future use, including as library files in a database for future production of components for a particular prosthesis assembly.

Embodiments of the present disclosure are also directed to improvements in fabricator technologies including, but not limited to, improvements in data storage, improvements in data retrieval, improvements to fabricator calibration, monitoring, and/or operation, and the like. Embodiments of the present disclosure are also directed to improvements in computer and/or database technologies including, but not limited to, improvements in data storage, improvements in data retrieval, improvements to dental prosthesis modelling and/or the software or hardware capable of performing the dental prosthesis modelling, improvements to the communication between the computer, database, and/or fabricator, and the like.

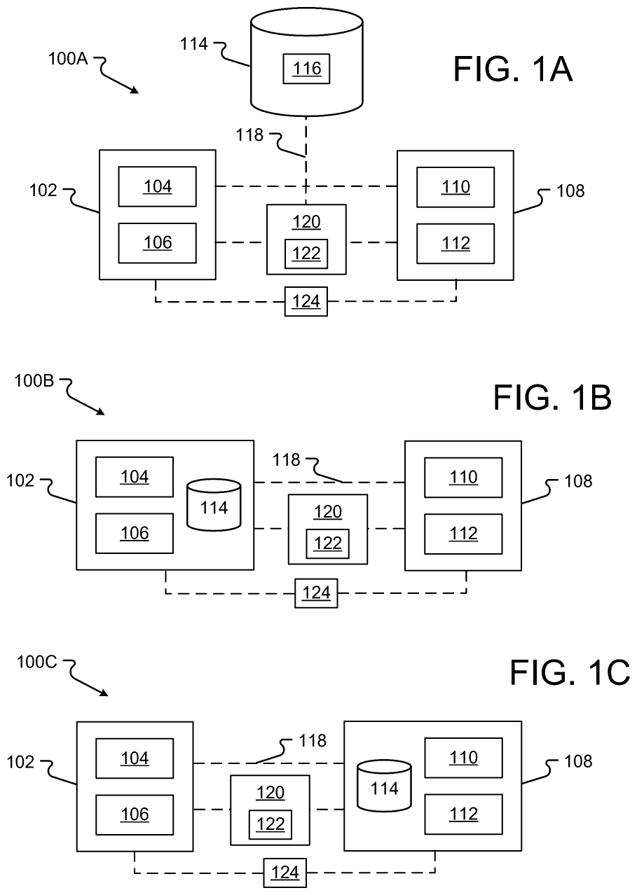

FIGS. 1A-IC illustrates variations of a system 100A, 100B, 100C for printing 3D components for dental prosthesis technologies, in accordance with one or more embodiments of the present disclosure.

In embodiments, the system 100A, 100B, 100C each includes a fabricator 102 with a processor 104 and memory 106 able to store program instructions configured to cause the processor 104 to execute one or more operations. For example, the fabricator 102 may include, but is not limited to, a three-dimensional (3D) printer, a computer numerical control (CNC) milling machine, and the like. In some configurations, the fabricator 102 is able to fabricate a dental prosthesis, at least one component of a dental prosthesis, and/or at least a portion of one or more components of a dental prosthesis, without departing from the scope of the present disclosure.

In embodiments, the system 100A, 100B, 100C each includes a computer 108 (or, generally, a computational system or computerized system) with a processor 110 and memory 112 able to store program instructions configured to cause the processor 110 to execute one or more operations. The computer 108 is coupled (e.g., physically coupled, electrically coupled, communicatively coupled, and the like) to the fabricator 102. In some configurations, the computer 108 may be a separate device coupled to the fabricator 102. By way of another example, the computer 108 and the fabricator 102 may be located within a common or shared housing.

In some embodiments, the processors 104, 110 may be configured to execute program instructions maintained on or stored in the memory 106, 112. It is contemplated that the processors 104, 110 may execute one or more of the various method or process steps of methods or processes 200 and/or 220, as described in detail further herein. In some embodiments, the memory 106, 112 may include a memory medium, a memory device, a computer-readable medium, a computer-readable storage medium, or the like.

The system 100A, 100B, 100C each includes a database 114 for storing a plurality of library files 116 (e.g., a collection of pre-determined library files, or other data). For example, the database 114 may be similar to the computer 108, with both a processor and memory (e.g., a memory medium, a memory device, a computer-readable medium, a computer-readable storage medium, or the like) able to store program instructions configured to cause the processor to execute one or more operations. By way of another example, the database 114 may include only memory. It is noted that the database 114 may be either a physical construct on which the digital set of library files is stored, or may be a digitally-stored set of library files, without departing from the scope of the present disclosure.

In some embodiments, as illustrated in system 100A of FIG. 1A, the database 114 with library files 116 may be an external database to both the fabricator 102 and the computer 108. For example, the fabricator 102, the computer 108, and the database 114 may be in possession of a single user (or within the same office or lab). By way of another example, the fabricator 102 and the computer 108 may be in the possession of a first user (e.g., a surgeon) and the database 114 may be in the possession of a lab technician, or vice versa. By way of another example, the fabricator 102 and the computer 108 may be in the possession of a user, and the database 114 may be a third-party database held by a developer and/or manufacturer of the fabricator 102. It should be understood that these are non-limiting examples, and that it is contemplated any number of actors may be in possession of one or more of the fabricator 102, the computer 108, and/or the database 114.

In other embodiments, as illustrated in system 100B of FIG. 1B, the database 114 with library files 116 may be provided with the fabricator 102, either in a separate housing from the fabricator 102, in a shared or common housing with the fabricator 102, or located within the fabricator 102. Although illustrated in FIG. 1B as being in addition to the memory 106, it should be understood that the database 114 may alternatively be instead of (e.g., and optionally operational as) the memory 106 of the fabricator 102, without departing from the scope of the present disclosure.

In further embodiments, as illustrated in system 100C of FIG. 1C, the database 114 with library files 116 may be provided with the computer 108, either in a separate housing from the computer 108, in a shared or common housing with the computer 108, or located within the computer 108. Although illustrated in FIG. 1C as being in addition to the memory 112, it should be understood that the database 114 may alternatively be instead of (e.g., and optionally operational as) the memory 112 of the computer 108, without departing from the scope of the present disclosure.

The system 100A, 100B, 100C includes communication channels 118 that allow for communication between one or more of the fabricator 102, the computer 108, the database 114, and/or other components (e.g., including external or third-party components) of the system 100A, 100B, 100C. In some embodiments, at least some of the communication channels 118 are wired and configured to transmit and/or receive data. In other embodiments, at least some of the communication channels 118 operate on wireless transmission protocols and configured to transmit and/or receive data.

In some non-limiting examples, the communication channels 118 may include one or more transmitters and/or receivers coupled (e.g., physically coupled, electrically coupled, communicatively coupled, or the like) to or integrated in the system 100A, 100B, 100C and/or components of the system 100A, 100B, 100C. The one or more transmitters and/or receivers may be configured to transmit data to and/or receive data from the system 100A, 100B, 100C, components of the system 100A, 100B, 100C, and/or from external third-party control units (e.g., controllers, servers, or the like) via wireless connections that may be configured as transmitting (Tx) units, receiving (Rx) units, or combination Tx/Rx units. Optionally, at least some of the communication channels 118 may be (or include) computer-readable signal mediums.

In some embodiments, the system 100A, 100B, 100C may include one or more user interfaces 120 coupled (e.g., physically coupled, electrically coupled, communicatively coupled, and the like) to the fabricator 102, the computer 108, and/or the database 114. For example, as illustrated in FIGS. 1A-1C, the user interface 120 may be a separate device coupled to the fabricator 102, the computer 108, and/or the database 114. By way of another example, the user interface 120 and the fabricator 102, the computer 108, and/or the database 114 may be located within a common or shared housing.

The user interface 120 may include one or more displays 122, one or more user input devices, and/or one or more port connectors (e.g., for the transmitting and/or receiving of power and/or data, and the like). For example, operational parameters of the fabricator 102 and/or of the computer 108, images from acquired scans, and/or virtual models of prostheses components may be viewable on the one or more displays 122, which may be adjusted and/or modified by an individual or user accessing the user interface 120.

The system 100A, 100B, 100C may include one or more sensors 124 coupled (e.g., physically coupled, electrically coupled, communicatively coupled, or the like) to or integrated in the fabricator 102, the computer 108, the database 114, and/or positioned within the environment surrounding the system 100A, 100B, 100C. For example, the one or more sensors 124 may be operable to determine various operational and/or physical parameters of the fabricator 102, the computer 108, the database 114. By way of another example, the one or more sensors 124 may be positioned within the environment surrounding the system 100A, 100B, 100C to acquire data about the surrounding environment. For instance, the sensors 124 may be operable to determine humidity and/or temperature of the environment surrounding the system 100A, 100B, 100C.

The system 100A, 100B, 100C may be configured to monitor the fabricator 102, the computer 108, the database 114, and/or any sensors 124 (e.g., including those positioned within the environment surrounding the system 100A, 100B, 100C) via received and/or transmitted data. In addition, the system 100A, 100B, 100C may be configured to generate control signals to adjust one or more components of the fabricator 102, the computer 108, the database 114, and/or the any sensors 124 (e.g., including those positioned within the environment surrounding the system 100A, 100B, 100C) via a feedback loop or a feed forward loop based on the received and/or transmitted data. Further, the system 100A, 100B, 100C may be configured to receive and/or transmit data in a standardized format and/or a non-standardized format. For instance, where the data is in a non-standardized format, the data may be converted to a standardized format upon receipt and/or prior to transmission to the fabricator 102, the computer 108, the database 114, and/or any sensors 124 (e.g., including those positioned within the environment surrounding the system 100A, 100B, 100C), third-party control units, or the like.

In some configurations, data may be acquired of the patient's mouth using (or from individuals who use) the sensors 124 and/or via user input devices of the user interface 120, without departing from the scope of the present disclosure. For example, data may be acquired based on recorded aural, haptic, or visual indicators. By way of another example, data may be acquired with scanning-based user input devices.

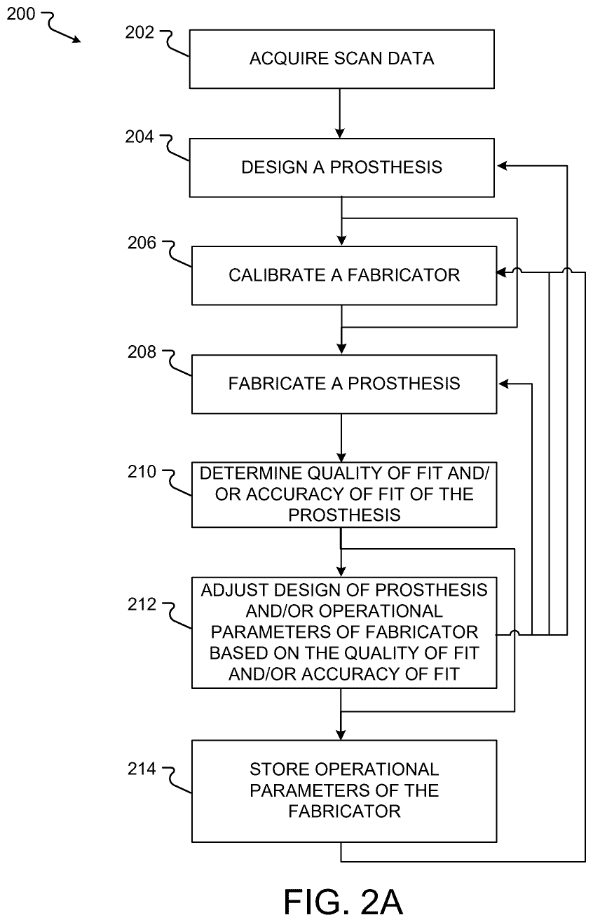

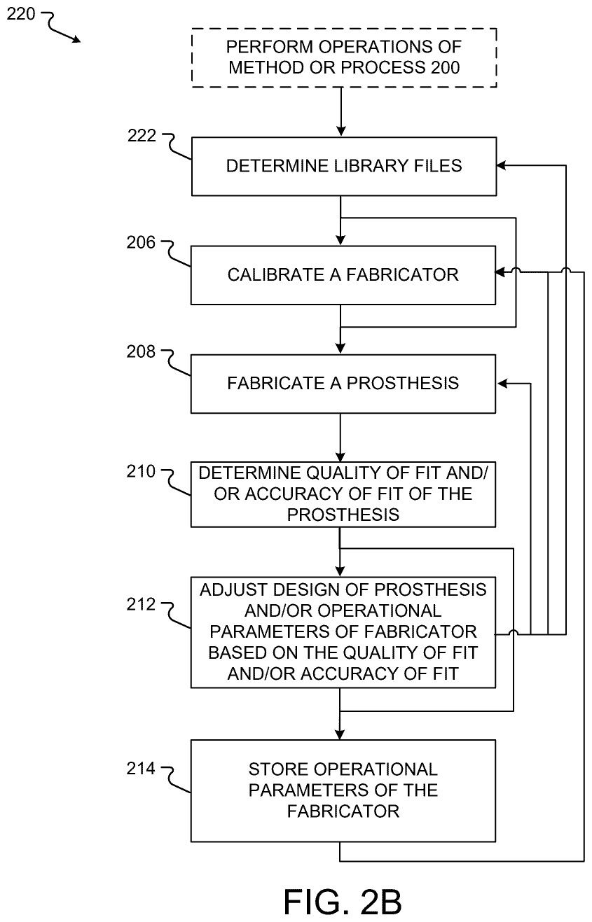

FIG. 2A illustrates a method or process 200 for printing 3D components for dental prosthesis technologies, in accordance with one or more embodiments of the present disclosure. It should be understood that some or all of the method or process 200 may be performed by and/or with components of the system 100A, 100B, 100C, as described throughout the present disclosure. While the method or process 200 is discussed and illustrated in relation to a particular sequence of events, it should be appreciated that changes, additions, and omissions to this sequence can occur without materially affecting the operation of the disclosed embodiments, configuration, and aspects.

In embodiments, scan data is acquired 202. For example, scan data may be acquired using (or from an individual who uses) ceiling-mounted, wall-mounted, or floor-mounted scanning technologies, handheld scanning technologies (e.g., a handheld wand, a smartphone or other device with a handheld camera, or the like) or other scanning technologies able to acquire scan data from an exterior or an interior of a patient's mouth including, but not limited to, a surface topography of the surgical site. For instance, the scan data may include, but is not limited to, computerized tomography (CT) scan data, Cone Beam Computed Tomography (CBCT) scan data, Magnetic Resonance Imaging (MRI) scan data, intra-oral scan data, jpeg/png/jpeg/RAW or other photo media-formatted scan data, and the like.

The acquired scan data may be utilized to design components of a prosthesis, where the prosthesis may be patient-specific and based on the acquired scan data. For example, the components may be custom-tailored or designed for a patient based on scans of the patient's mouth. For instance, the scans may include images or datasets related to contoured surfaces within the patient's mouth. By way of another example, the scans may include images or datasets of a temporary prosthesis (e.g., a healing abutment, or the like) installed within the patient's mouth, for use during design and fabrication (e.g., 3D printing) of final components of the prosthesis for permanent or semi-permanent installation within the patient.

It is noted that the acquiring 202 of scan data of the patient's mouth may be optional, such as where a first individual (e.g., a lab technician, a clinician, a surgeon, or another medical professional; a patient or another non-medical professional; or the like) provides the scans or other data and a second individual (e.g., a lab technician, a clinician, a surgeon, or another medical professional) receives the scans. In this regard, the scans may be acquired by the second individual without completing the actual scanning, without departing from the scope of the present disclosure.

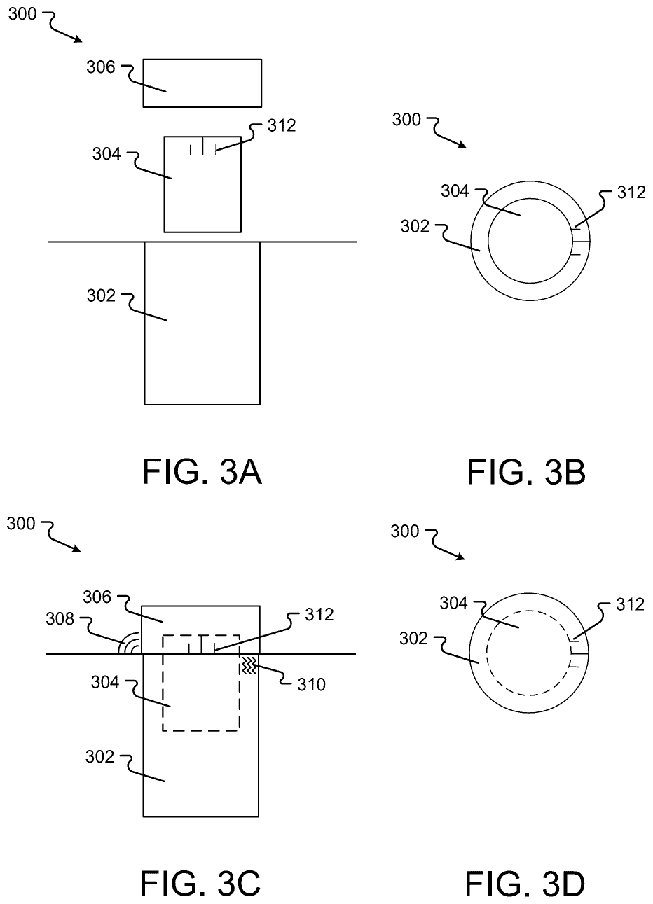

In embodiments, a prosthesis is designed 204. The components of the prosthesis may be designed based on the scans of the patient's mouth. For example, the prosthesis may be virtually modelled using 3D-modelling software based on the scans of the patient's mouth. In some configurations of the prosthesis, the components of the prosthesis may at least include an implant that is installed at a predetermined depth beneath a gum line and within a jawbone, and an abutment that is inserted into the implant. Optionally, where the abutment does not include the contacting surfaces for use by a patient to chew after the abutment is installed within the patient's mouth, the components of the prosthesis may optionally further include a crown that fits on (or over) the abutment and includes the necessary contacting surfaces. Exemplary illustrations of a prosthesis 300 including an implant 302, an abutment 304, and a crown 306 are shown in FIGS. 3A-3D. It is noted that the components of the prosthesis may be for a single tooth configuration, or for a partial or full arch for the replacement of multiple teeth.

It is noted that the designing 204 of the components of the prosthesis may be optional, such as where a first individual (e.g., a lab technician, a clinician, a surgeon, or another medical professional) receives designs for the components of the prosthesis from a second individual (e.g., a lab technician, a clinician, a surgeon, or another medical professional), which were produced based on scans of the patient's mouth. In this regard, the designs for the components of the prosthesis may be acquired by the first individual without completing the actual designing, without departing from the scope of and the present disclosure. In addition, it is noted that the designing 204 of the prosthesis may occur with, or separately from, the acquiring 202 of the method or process 200. For example, a single individual may perform the acquiring 202 and the designing 204. By way of another example, a first individual (e.g., a lab technician, a clinician, a surgeon, or another medical professional; a patient or another non-medical professional; or the like) completes the acquiring 202, and a second individual may design 204 the prosthesis.

In addition, it is noted that the acquiring 202 and/or the designing 204 may be optional, such as where the library files of stored geometries are created by a user entirely with virtual modeling techniques or technologies (e.g., computer-aided design file generation, and the like).

In embodiments, a fabricator is calibrated 206. A fabricator may include, but is not limited to, a fabricator 102 that may require calibration to improve the accuracy of the fabrication of the components of the prosthesis. Calibration of the fabricator 102 may reduce or remove sources of error (e.g., either individual sources of error or stacked sources of error) that may otherwise impact the accuracy of the fabrication of the components of the prosthesis.

In some non-limiting examples, the fabricator 102 may be pre-calibrated based on a global design file (or other library file) for a global test component, which may be accessed by a user (e.g., a lab technician, a clinician, a surgeon, or another medical professional) from a database 114 for fabrication. For instance, the database 114 may be within the fabricator 102, may be within the computer 108 in communication with the fabricator 102, may be a third-party or external server database 114, or the like. In some instances, the global design file for a global test component may be specific to a particular fabricator 102.

By way of another example, the fabricator 102 may be pre-calibrated based on a set of library files 116 prior to fabrication of the components of the prosthesis. The pre-calibration may take into consideration operational parameters of the fabricator 102 (e.g., either pre-determined for the particular fabricator 102 and/or observed by sensors 124 within or proximate to the fabricator 102), material properties of the fabrication material (e.g., resin, or the like) used to fabricate the components of the prosthesis, properties of the surrounding environment (e.g., observed by sensors 124, such as temperature or humidity), and the like.

In some configurations, the library files 116 may include a virtual model for the prosthesis. Alternatively or in addition, the library files 116 may include operational parameters for the fabricator including, but not limited to, operating temperature, fabrication material, and the like. Further, the library files 116 may include comparative information for determining a quality of fit including comparative aural indicators, haptic indicators, and/or visual indicators. Further, the library files 116 may include comparative information for determining an accuracy of fit including comparative measurements or dimensions for individual components and/or assemblies of components of the prosthesis (e.g., including the entire prosthesis).

It is noted that the calibrating 206 of the fabricator may be optional, such as where the fabricator is pre-calibrated, is hermetically sealed from exterior disturbances after construction, and/or has previously undergone calibration within an acceptable timeframe, without departing from the scope of the present disclosure. In addition, it is noted that the calibrating 206 of the fabricator may occur with, or separately from, the acquiring 202 and/or the designing 204 of the method or process 200. For example, a single individual may perform each of the acquiring 202, the designing 204, and the calibrating 206. By way of another example, one or more first individuals (e.g., a lab technician, a clinician, a surgeon, or another medical professional; a patient or another non-medical professional; or the like) completes one or more of the acquiring 202 and/or the designing 204, and one or more second individuals may calibrate 206 the fabricator.

In embodiments, the prosthesis is fabricated 208. For example, one or more components of the prosthesis may be 3D-printed from design files (or other library files), which may be accessed by a user (e.g., a lab technician, a clinician, a surgeon, or another medical professional) from a database 114 for fabrication. For instance, the database 114 may be within the fabricator 102, may be within the computer 108 in communication with the fabricator 102, may be a third-party or external server database 114, or the like. In some configurations, the fabricator 102 is able to fabricate a prosthesis, at least one component of a prosthesis, and/or at least a portion of one or more components of a prosthesis, without departing from the scope of the present disclosure.

It is noted that the fabricating 208 of the prosthesis may occur with, or separately from, the acquiring 202, the designing 204, and/or the calibrating 206 of the method or process 200. For example, a single individual may perform each of the acquiring 202, the designing 204, the calibrating 206, and the fabricating 208. By way of another example, one or more first individuals (e.g., a lab technician, a clinician, a surgeon, or another medical professional; a patient or another non-medical professional; or the like) completes one or more of the acquiring 202, the designing 204, and/or the calibrating 206, and one or more second individuals may fabricate 208 the prosthesis.

In embodiments, a quality of fit and/or an accuracy of fit is determined 210 for the components of the prosthesis. The quality of fit and/or the accuracy of fit may be dependent on factors including, but not limited to, interconnectivity between the components of the prosthesis. In addition, the quality of fit and/or the accuracy of fit may be dependent on factors including, but not limited to, positioning (e.g., including location and/or orientation) of the components of the prosthesis within a patient's mouth (and existing structures therein that are proximate to the prosthesis when installed), dimensions of the components (either individually or stacked) within the patient's mouth, and the like.

In some configurations of the prosthesis, the quality of fit may be determined for the engagement of an abutment to an implant, a crown to the abutment, or other engaging feature or set of engaging features between various components of the prosthesis. The quality of fit may be assessed through an indicator such as a visual indicator, a haptic indicator, or an aural indicator. The indicator may be acquired (e.g., recorded, or the like), quantifiably assessed, and/or compared to library files 116 within the database 114 (or other data).

For example, an aural indicator may include a sound at (or resulting from) a natural sound that occurs when the components of the prosthesis engage (e.g., a snap or click together). For example, the natural sound may be dependent on the material from which the components are fabricated. Alternatively or in addition, the natural sound may be dependent on formed features on or within the components that engage when the components engage one another. By way of another example, the aural indicator may include an artificial sound formed by secondary features installed on (or in) the engagement surfaces of the components of the prosthesis. The aural indicator may assist in determining whether the correct material was used to fabricate the components of the prosthesis. The aural indicator may assist in determining whether the dimensions of mating surfaces of the component of the prosthesis are within pre-determined tolerances when the components of the prosthesis engage (or, in general, assist in determining whether the components of the prosthesis do engage via the mating surfaces). It is noted that a non-limiting example of an aural indicator 308 is illustrated in a comparison of FIGS. 3A and 3C, where the engagement of the crown 306 to the abutment 304 emits a sound.

Where the indicator is a recorded aural indicator, the recorded aural indicator may be compared to a database (or other data) with pre-recorded sounds that represent correct calibration of the fabricator 102 and/or fabrication of the components of the prosthesis. For example, comparison between the recorded aural indicator and the pre-recorded sounds may assist in determining whether the fabricator 102 correctly fabricated the components of the prosthesis, should the recorded aural indicator (e.g., either a sound derived from a natural frequency or an artificial sound created by features on the components) fall at a pre-determined value or frequency (or within a pre-determined threshold or range of values or frequencies) of the stored pre-recorded aural indicators. For instance, comparison between the recorded aural indicators and the pre-recorded sounds may assist in determining whether mating surfaces are correctly formed to ensure proper connection between the components of the prosthesis, should the recorded aural indicator fall at a pre-determined value or frequency (or within a pre-determined threshold or range of values or frequencies) of the stored pre-recorded sounds.

It is noted that the determining the quality of fit based on aural responses may include, but is not limited to, a comparison between the outputted sound and pre-recorded sound based on pitch or frequency, decibel or loudness, tone, and the like. For example, a threshold for sound may be based on a pitch or frequency that is within +/−500 cents of a pre-recorded frequency, optionally within +/−100 cents of a pre-recorded frequency, optionally within +/−50 cents of a pre-recorded frequency, optionally within +/−10 cents of a pre-recorded frequency, optionally within +/−5 cents of a pre-recorded frequency, and optionally within +/−1 cents of a pre-recorded frequency or any frequency or range of frequencies within the example bounded ranges (e.g., between −275 cents and +150 cents). By way of another example, a threshold for sound may be based on a decibel or loudness (dB) that is within +/−500% of a pre-recorded decibel level, optionally within +/−100% of a pre-recorded decibel level, optionally within +/−50% of a pre-recorded decibel level, optionally within +/−10% of a pre-recorded decibel level, optionally within +/−5% of a pre-recorded decibel level, and optionally within +/−1% of a pre-recorded decibel level, or any decibel level or range of decibel levels in the example bounded ranges (e.g., between −275% and +150%).

It is noted that the determining the quality of fit based on haptic responses may include, but is not limited to, a comparison between an amount of force (e.g., in Newtons (N)) required to connect the components of the prosthesis and a pre-recorded amount of force. For example, a threshold for the amount of force may be based on an amount of force that is within +/−500% of a pre-recorded amount of force, optionally within +/−100% of a pre-recorded amount of force, optionally within +/−50% of a pre-recorded amount of force, optionally within +/−10% of a pre-recorded amount of force, optionally within +/−5% of a pre-recorded amount of force, and optionally within +/−1% of a pre-recorded amount of force, or any amount of force or range of amounts of force in the example bounded ranges (e.g., between −275% and +150%).

In another non-limiting example, the library files may include calibration features that are created on the components of the prosthesis when fabricated 208. For example, the calibration features may include any number of adjacent or overlaid shapes, patterns, colors or layers, (e.g., where multiple different materials are available and in use within the fabricator 102). For instance, the calibration features may include a series of indicator markings that provide a visual and/or a haptic indicator of correct calibration. It is noted that a non-limiting example of a haptic indicator 310 is illustrated in a comparison of FIGS. 3A and 3C, where the engagement of the abutment 304 to the implant 302 produces a haptic response at least observable during installation. In addition, it is noted that a non-limiting example of a visual indicator 312 is illustrated in a comparison of FIGS. 3A/3B and 3C/3D, where indicator markers on a side surface of the abutment 304 an a top surface of the implant 302 align when the abutment 304 engages the implant 302. Further, it is noted the visual and/or haptic indicators may be created in addition to (or instead of) the mating surfaces or other features that produce an aural indicator for determining 210 a quality of fit.

It is noted that the determining the quality of fit based on visual responses may include, but is not limited to, a comparison between an alignment and/or overlap (e.g., in millimeters (mm)) of indicators on the components of the prosthesis and a pre-recorded alignment and/or overlap. For example, a threshold for the alignment or overlap may be based on misalignment or offsetting within +/−500% of true alignment or overlap, optionally within +/−100% of true alignment or overlap, optionally within +/−50% of true alignment or overlap, optionally within +/−10% of true alignment or overlap, optionally within +/−5% of true alignment or overlap, and optionally within +/−1% of true alignment or overlap, or any amount of misalignment or offsetting or range of amounts of misalignment or offsetting in the example bounded ranges (e.g., between −275% and +150%).

In some configurations of the prosthesis, the accuracy of fit may be determined for the engagement of an abutment to an implant, a crown to the abutment, or other engaging feature or set of engaging features between various components of the prosthesis. The accuracy of fit may be assessed for measurements or dimensions taken of individual components and/or of a stack or assembly of a component of components, including optionally the entire prosthesis. The measurements and/or dimensions of the prosthesis and its components may be acquired (e.g., recorded, or the like), quantifiably assessed, and/or compared to library files 116 within a database 114 with comparative threshold values (or other data).

It is noted that the determining the accuracy of fit based on measurements or dimensions may include, but is not limited to, a comparison between one or more measurements or dimensions (e.g., in millimeters (mm)) between the virtually-modelled or physically-fabricated prosthesis component and a standard or known (either physical or virtual) for the prosthesis component. For example, a threshold for the deviation of a measurement or dimension may be based within +/−500% of a standard or known measurement or dimension, optionally within +/−100% of a standard or known measurement or dimension, optionally within +/−50% of a standard or known measurement or dimension, optionally within +/−10% of a standard or known measurement or dimension, optionally within +/−5% of a standard or known measurement or dimension, and optionally within +/−1% of a standard or known measurement or dimension, or any measurement or dimension or range of measurements or dimensions in the example bounded ranges (e.g., between −275% and +150%).

It is noted that the determining 210 of the quality of fit and/or the accuracy of fit of the prosthesis may occur with, or separately from, the acquiring 202, the designing 204, the calibrating 206, and/or the fabrication 208 of the method or process 200. For example, a single individual may perform each of the acquiring 202, the designing 204, the calibrating 206, the fabricating 208, and the determining 210. By way of another example, one or more first individuals (e.g., a lab technician, a clinician, a surgeon, or another medical professional; a patient or another non-medical professional; or the like) completes one or more of the acquiring 202, the designing 204, the calibrating 206, and/or the fabricating 208, and one or more second individuals may determine 210 the quality of fit and/or the accuracy of fit of the prosthesis.

In embodiments, the design of the prosthesis and/or operational parameters of the fabricator are adjusted 212 based on the quality of fit and/or the accuracy of fit.

Should the quality of fit and/or the accuracy of fit be determined to be outside of a pre-determined value (or threshold or range of values), the design of the prosthesis may be virtually modified through one or more iterations. For example, features of one or more components of the prosthesis may be modified using 3D-modeling technologies with the computer 108 to more closely align with the desired quality of fit and/or accuracy of fit for the patient. By way of another example, features of one or more components of the prosthesis may be physically modified to more closely align with the desired quality of fit and/or accuracy of fit for the patient.

Alternatively or in addition, should the quality of fit and/or accuracy of fit be determined to be outside of a pre-determined value (or threshold or range of values), one or more operational parameters of the fabricator 102 may be adjusted through one or more iterations. For example, the one or more operational parameters may be adjusted directly on the fabricator 102, including with temperature adjustments, changes to fabrication material, or the like. By way of another example, the design file (or other library file) for the components of the prosthesis may be updated or re-selected based on the determined quality of fit and/or accuracy of fit, and the one or more operational parameters of the fabricator 102 may be adjusted based on the updated design file (or other library file).

In some non-limiting examples, such as where the components of the prosthesis have been initially fabricated 208 and adjustment 212 of the prosthesis and/or the fabricator 102 is required following the determination 210 of the quality of fit and/or accuracy of fit, the method or process 200 may be iteratively performed. For instance, the iterative performing of the method or process 200 may include, but is not limited to, acquiring 202 scan data from additional scans, re-designing 204 the components of the prosthesis based on the acquired additional scans, re-calibrating 206 the fabricator, re-fabricating 208 the prosthesis, and/or re-determining 210 a quality of fit and/or accuracy of fit when performing the adjustment 212. In this regard, the design of the components of the prosthesis may be iteratively reviewed, until a prosthesis with a quality of fit and/or accuracy of fit within a pre-determined threshold of acceptance is determined, via the method or process 200.

It is noted, however, that the adjusting 212 of the design of the prosthesis and/or operational parameters of the fabricator may be optional, such as where the quality of fit and/or accuracy of fit is determined to be at the pre-determined value (or within the threshold or range of values), without departing from the scope of the disclosure. In addition, it is noted that the adjusting 212 of the fabricator may occur with, or separately from, the acquiring 202, the designing 204, the calibrating 206, the fabrication 208, and/or the determining 210 of the method or process 200. For example, a single individual may perform each of the acquiring 202, the designing 204, the calibrating 206, the fabricating 208, the determining 210, and the adjusting 212. By way of another example, one or more first individuals (e.g., a lab technician, a clinician, a surgeon, or another medical professional; a patient or another non-medical professional; or the like) completes one or more of the acquiring 202, the designing 204, the calibrating 206, the fabricating 208, and/or the determining 210, and one or more second individuals may adjust 212 the fabricator.

In embodiments, operational parameters of the fabricator are stored 214. The operational parameters may be stored for further usage and calibration. In some non-limiting examples, such as where the components of the prosthesis are fabricated from geometries determined to be at the pre-determined value (or within the threshold or range of values), the operational parameters of the fabricator 102 may be stored as a library file 116 for future use. For instance, the operational parameters of the fabricator 102 may be stored for pre-calibration prior to fabrication of another set of components of the prosthesis (e.g., either by the same fabricator 102 or by another fabricator 102).

It is noted the storing 214 of the operational parameters may be optional, such as where the fabricator 102 is pre-calibrated using a global design file or other library file, without departing from the scope of the disclosure. In addition, it is noted that the storing 214 of the operational parameters may occur with, or separately from, the acquiring 202, the designing 204, the calibrating 206, the fabrication 208, the determining 210, and/or the adjusting 212 of the method or process 200. For example, a single individual may perform each of the acquiring 202, the designing 204, the calibrating 206, the fabricating 208, the determining 210, the adjusting 212, and the storing 214. By way of another example, one or more first individuals (e.g., a lab technician, a clinician, a surgeon, or another medical professional; a patient or another non-medical professional; or the like) completes one or more of the acquiring 202, the designing 204, the calibrating 206, the fabricating 208, the determining 210, and/or the adjusting 212, and one or more second individuals may store 214 the operational parameters.

In some examples, the stored operational parameters for accepted geometries may be compiled in a repository as library files, either locally (e.g., within the fabricator 102, the computer 108 in communication with the fabricator 102, or a database 114 in proximate location with the fabricator 102 and/or the computer 108) or globally (e.g., within a database 114 or other external server or computer). The fabricator 102 may be in communication with the local or global repository of library files 116, and may request and receive updated design files for the components of the prosthesis from the repository.

FIG. 2B illustrates a method or process 220 for printing 3D components for dental prosthesis technologies, in accordance with one or more embodiments of the present disclosure. It should be understood that some or all of the method or process 220 may be performed by and/or with components of the system 100A, 100B, 100C, as described throughout the present disclosure. While the method or process 220 is discussed and illustrated in relation to a particular sequence of events, it should be appreciated that changes, additions, and omissions to this sequence can occur without materially affecting the operation of the disclosed embodiments, configuration, and aspects.

In embodiments, library files are determined 222 based on inputs from a user. A user (e.g., a lab technician, a clinician, a surgeon, or another medical professional) may provide inputs via the user interface 120 about desired parameters for components of a prosthesis. The fabricator 102, the computer 108, and/or the database 114 may determine a geometry based on the inputs including, but not limited to, from a non-limited number of variations (e.g., where there are 100 geometries, geometry 77 may be determined based on the inputs), and provide or otherwise queue the corresponding library files 116.

In some non-limiting examples, the stored geometries may be created by a user entirely with virtual modeling techniques or technologies (e.g., computer-aided design file generation, and the like), and/or via one or more operations of the method or process 200, as described throughout the present disclosure. It is noted this may occur prior to the determining 222 of the process 220. However, it should be understood that the one or more operations of the method or process 200 being performed prior to the performing the operations of the method or process 200, may be optional with respect to the performing of the operations of the method or process 220, without departing from the scope of the present disclosure.

The determined geometry may be automatically provided to the user, or may be provided following a separate prompt from the user (e.g., which may be received via the user interface 120). The user may review the determined geometry and provide additional inputs via the user interface 120 to confirm the selection, request a different selection, or provide instructions to refine the selection.

Where instructions to refine the selection are provided, the fabricator 102, the computer 108, and/or the database 114 may review library sub-files for the determined geometry of the non-limited number of variations (e.g., for geometry 77 out of 100), to refine the determined geometry to reflect stored variations. For instance, the variations may be related to fabricator-specific personality features or characteristics, characteristics of the material to be used for fabrication of the components of the prosthesis, real-time (or nearly real-time) data related to the environment surrounding the fabricator, or the like. It is noted this information may be input by the user, or may be stored and automatically recalled by the fabricator 102, the computer 108, and/or the database 114, during refinement. In addition, it is noted that refinement of the initial determined geometry may occur automatically (e.g., without prompt from the user) by the fabricator 102, the computer 108, and/or the database 114, prior to providing of any determined geometry to the user.

Alternatively or in addition, the user may refine the selection using modeling techniques with the computer 108, to design the prosthesis for the specific patient, without departing from the scope of the present disclosure.

In embodiments, the method or process 220 may include one or more of calibration 206, fabrication 208, determination 210 of a quality of fit and/or an accuracy of fit, adjusting 212 of operational parameters, and/or storing 214 of operational parameters, as described with respect to method or process 200 and throughout the present disclosure.

In some non-limiting examples, where the components of the prosthesis have been fabricated 208 and the quality of fit and/or accuracy of fit has been determined 210, adjustment 212 may be required. The method or process 220 may include, but is not limited to, determining 222 a different library file and/or additionally calibrating 206 the fabricator when performing the adjustment 212. In this regard, the design of the components of the prosthesis may be iteratively reviewed, until a prosthesis with a quality of fit and/or accuracy of fit within a pre-determined threshold of acceptance is determined, via the method or process 220.

In additional non-limiting examples, such as where the components of the prosthesis are successfully fabricated from accepted geometries, the operational parameters of the fabricator 102 may be stored as a library file 116 for future use, including for pre-calibration prior to fabrication of another set of components of the prosthesis (e.g., either by the same fabricator 102 or by another fabricator 102).

It is noted that any of the operations 202, 204, 206, 208, 210, 212, 214, 222 may be performed by one or more individuals including one or more individuals or companies who own or lease/rent/borrow the fabricator 102, the computer 108, and/or the database 114, without departing from the scope of the present disclosure. In addition, it is noted that any of the operations 202, 204, 206, 208, 210, 212, 214, 222 may be performed by one or more individuals including one or more individuals who are employed by an individual or companies that owns or leases/rents/borrows the fabricator 102, the computer 108, and/or the database 114, without departing from the scope of the present disclosure. Further, it is noted that any of the operations 202, 204, 206, 208, 210, 212, 214, 222 may be performed by one or more individuals including one or more individuals or companies who manufactures the fabricator 102, the computer 108, and/or the database 114, without departing from the scope of the present disclosure.

Any of the steps, functions, and operations discussed herein can be performed continuously and automatically. It should be understood that aspects of the process 200 may be performed in an automatic or nearly automatic capacity by components of the system 100A, 100B, 100C. The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate” and “compute,” and variations thereof, as may be used herein, are used interchangeably and include any type of methodology, process, mathematical operation or technique, for purposes of the present disclosure.

In general, it should be understood that portions of the present disclosure may be considered directed to a “computer-implemented invention.” For example, the system 100A, 100B, 100C may, in some embodiments, be a “computer-implemented system”, for purposes of the present disclosure. In addition, it should be understood that the methods or processes 200. 220 may, in some embodiments, be a “computer-implemented method”, for purposes of the present disclosure. It is noted that, in some configurations, the computer-implemented system may include a special-purposes computer 108 that is operable with the fabricator 102 and the database 114 as described throughout the present disclosure.

Examples of the processors 104, 110 used for the systems 100A, 100B, 100C and methods or processes 200, 220 as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

The systems 100A, 100B, 100C and methods or processes 200, 220 of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

The disclosed methods or processes 200, 220 may be readily implemented in conjunction with software using object or object-oriented software development environments that provide portable source code that can be used on a variety of computer or workstation platforms. Alternatively, the disclosed systems 100A, 100B, 100C may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

The disclosed methods or processes 200, 220 may be partially implemented in software that can be stored on a storage medium, executed on a programmed general-purpose computer with the cooperation of a controller with processors and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The term “computer-readable medium” (e.g., with respect to the memory 106, 112 and/or the database 114) as may be used herein refers to any computer-readable storage and/or transmission medium that participates in providing instructions to a processor for execution. Such a computer-readable medium can be tangible, non-transitory, and non-transient and take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “computer readable storage medium” may be, for example, but not limited to, an electronic, magnetic, optical, electromagnetic, infrared, or semiconductor system, apparatus, or device, or any suitable combination of the foregoing. More specific examples (e.g., which are provided as a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

A computer readable signal medium may be any computer readable medium that is not a computer readable storage medium and that can communicate, propagate, or transport a program for use by or in connection with an instruction execution system, apparatus, or device. A computer readable signal medium may convey a propagated data signal with computer readable program code embodied therein, for example, in baseband or as part of a carrier wave. Such a propagated signal may take any of a variety of forms, including, but not limited to, electro-magnetic, optical, or any suitable combination thereof. Program code embodied on a computer readable signal medium may be transmitted using any appropriate medium, including but not limited to wireless, wireline, optical fiber cable, RF, etc., or any suitable combination of the foregoing.

In embodiments, the fabricator 102, the computer 108, and/or the database 114 may include one or more modules. For example, the modules may operate on, be in addition to, or be instead of the processors 104, 110 and/or memory 106, 112. The term “module” as used herein refers to any known or later developed hardware, software, firmware, artificial intelligence, fuzzy logic, or combination of hardware and software that is capable of performing the functionality associated with that element.

In this regard, advantages of the present disclosure include, but are not limited to, printing three-dimensional objects as part of a digital dental workflow. In particular, advantages of the present disclosure are directed to systems and methods for printing three-dimensional components for dental prosthesis technologies.

Advantages of the present disclosure also include, but are not limited to, systems and methods that utilize a fabricator to fabricate components of a prosthesis based on library files. Library files are selected based on acquired scan data of a patient (and/or may be designed based on the acquired scan data). The library files may be selected following inputs from a user (e.g., a lab technician, a clinician, a surgeon, or another medical professional). The generated design and/or the library files include a particular geometry (or geometries) for the prosthesis (and the components of the prosthesis).

Advantages of the present disclosure include fabricating the components of the prosthesis, and determining a quality of fit and/or accuracy of fit for the fabricated parts. The quality of fit may be based on haptic, visual, and/or aural indicators. The indicators may be compared to standard indicators (or other data), to determine whether the value (or a threshold or range of values) is met by the fabricated components of the prosthesis. The accuracy of fit may be based on measurements or dimensions of the individual components of the prosthesis and/or assemblies of the components. The measurements or dimensions may be compared to pre-determined measurements or dimensions (or other data), to determine whether the value (or a threshold or range of values) is met by the fabricated components of the prosthesis. Where the value (or a threshold or range of values) is not met, the components of the prosthesis and/or operational parameters of the fabricator may be modified or reproduced through one or more iterations until the value (or a threshold or range of values) is met.

Advantages of the present disclosure include adjusting operational parameters of the fabricator based on the components of the prosthesis, aspects of the fabricator, properties of the material used to fabricate the components of the prosthesis, and/or from the surrounding environment. Advantages of the present disclosure include storing operational parameters of the fabricator for future use, including as library files in a database for future production of component for a particular prosthesis assembly.

Advantages of the present disclosure are also directed to improvements in fabricator technologies including, but not limited to, improvements in data storage, improvements in data retrieval, improvements to fabricator calibration, monitoring, and/or operation, and the like. Advantages of the present disclosure are also directed to improvements in computer and/or database technologies including, but not limited to, improvements in data storage, improvements in data retrieval, improvements to dental prosthesis modelling and/or the software or hardware capable of performing the dental prosthesis modelling, improvements to the communication between the computer, database, and/or fabricator, and the like.

The exemplary systems and methods of this disclosure have been described in relation to dental restoration digital workflows. However, to avoid unnecessarily obscuring the present disclosure, the preceding description omits a number of known structures and devices. This omission is not to be construed as a limitation of the scope of the claims. Specific details are set forth to provide an understanding of the present disclosure. It should however be appreciated that the present disclosure may be practiced in a variety of ways beyond the specific detail set forth herein.

While various embodiments of the present disclosure have been described in detail, it is apparent that modifications and alterations of those embodiments will occur to those skilled in the art. However, it is to be understood that such modifications and alterations are within the scope and spirit of the present disclosure, as set forth in the following claims. Further, the disclosure described herein is capable of other embodiments and of being practiced or of being carried out in various ways. It is to be understood that the phraseology and terminology used herein is for the purpose of description and should not be regarded as limiting.

A number of variations and modifications of the disclosure can be used. It would be possible to provide for some features of the disclosure without providing others. The present disclosure, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for fabricating three-dimensional components for dental prosthesis technologies, the system comprising:
a fabricator for fabricating at least one component of a dental prosthesis; and
a computer including a processor and computer readable medium comprising instructions that, when executed, cause the processor to:
calibrate the fabricator, wherein the fabricator is calibrated based on a library file of a collection of pre-determined library files, and wherein the library file includes at least one of:
a virtual model for the at least one component of the dental prosthesis to be fabricated; and
one or more operational parameters for the fabricator;
fabricate the at least one component of the dental prosthesis using the fabricator; and
determine at least one of a quality of fit and an accuracy of fit of the at least one component of the dental prosthesis.

2. The system of claim 1, wherein the library file is selected based on at least one of:
inputs received from a user via the computer; and
acquired scan data of a patient.

3. The system of claim 2, wherein the collection of pre-determined library files is stored in a database.

4. The system of claim 2, wherein the instructions, when executed, cause the processor to acquire the scan data of the patient.

5. The system of claim 4, wherein the instructions, when executed, cause the processor to design the virtual model of the at least one component of the dental prosthesis based on the acquired scan data.

6. The system of claim 1, wherein the at least one component of the dental prosthesis includes a first component and a second component, and wherein the quality of fit and/or the accuracy of fit is determined during engagement of the first component and the second component based on an indicator.

7. The system of claim 6, wherein the indicator is an aural indicator emitted during engagement of the first component and the second component, and wherein the aural indicator emitted during engagement of the first component and the second component is dependent on at least one of:
a material from which at least one of the first component and the second component is fabricated; and
one or more features formed on at least one of the first component and the second component.

8. The system of claim 7, wherein the aural indicator emitted during engagement of the first component and the second component is compared to a pre-determined aural indicator stored in the computer readable medium of the computer.

9. The system of claim 6, wherein the indicator is a haptic indicator generated during engagement of the first component and the second component.

10. The system of claim 6, wherein the indicator is a visual indicator observed during engagement of the first component and the second component, wherein the visual indicator includes one or more indicator markers formed on at least one of the first component and the second component.

11. The system of claim 1, wherein the instructions, when executed, cause the processor to:
adjust the at least one component of the dental prosthesis based on the determined at least one of a quality of fit and an accuracy of fit by modifying the virtual model of the at least one component of the dental prosthesis, where the determined at least one of a quality of fit and an accuracy of fit does not meet a pre-determined threshold; and
re-fabricate the at least one component of the dental prosthesis using the fabricator based on the modified virtual model.

12. The system of claim 1, wherein the instructions, when executed, cause the processor to adjust one or more operational parameters of the fabricator based on the determined at least one of a quality of fit and an accuracy of fit, where the determined at least one of a quality of fit and an accuracy of fit does not meet a pre-determined threshold.

13. The system of claim 1, wherein the instructions, when executed, cause the processor to store one or more operational parameters of the fabricator, where the determined at least one of a quality of fit and an accuracy of fit does meet a pre-determined threshold.

14. A method for fabricating three-dimensional components for dental prosthesis technologies, the method comprising:
calibrating a fabricator for manufacturing at least one component of a dental prosthesis, wherein the fabricator is calibrated based on a library file of a collection of pre-determined library files, and wherein the library file includes at least one of:
a virtual model for the at least one component of the dental prosthesis to be fabricated; and
one or more operational parameters for the fabricator;
fabricating the at least one component of the dental prosthesis using the fabricator; and
determining at least one of a quality of fit and an accuracy of fit of the at least one component of the dental prosthesis.

15. The method of claim 14, further comprising at least one of:
acquiring scan data of a patient; and
receiving inputs from a user,
wherein the library file is selected based on the acquired scan data and/or the received inputs.

16. The method of claim 15, further comprising:
designing the virtual model of the at least one component of the dental prosthesis based on the acquired scan data.

17. The method of claim 14, further comprising:
adjusting the at least one component of the dental prosthesis based on the determined at least one of a quality of fit and an accuracy of fit by modifying the virtual model of the at least one component of the dental prosthesis, where the determined at least one of a quality of fit and an accuracy of fit does not meet a pre-determined threshold; and
re-fabricating the at least one component of the dental prosthesis using the fabricator based on the modified virtual model.

18. The method of claim 14, further comprising:
adjusting one or more operational parameters of the fabricator based on the determined at least one of a quality of fit and an accuracy of fit, where the determined at least one of a quality of fit and an accuracy of fit does not meet a pre-determined threshold.

19. The method of claim 14, further comprising:
storing one or more operational parameters of the fabricator, where the determined at least one of a quality of fit and an accuracy of fit does meet a pre-determined threshold.

20. A non-transient computer-readable medium having stored thereon instructions that cause a processor to execute a method, the method comprising instructions to:
calibrate a fabricator for manufacturing at least one component of a dental prosthesis, wherein the fabricator is calibrated based on a library file of a collection of pre-determined library files, and wherein the library file includes at least one of:
a virtual model for the at least one component of the dental prosthesis to be fabricated; and
one or more operational parameters for the fabricator;
provide fabrication instructions to the fabricator to fabricate the at least one component of the dental prosthesis; and
determine at least one of a quality of fit and an accuracy of fit of the at least one component of the dental prosthesis.
